(19) United States
(12) Patent Application Publication
(10) Pub. No.: US 2026/0012091 A1
(43) Pub. Date: Jan. 8, 2026

(54) Circuit Device And Switching Regulator

(71) Applicant: SEIKO EPSON CORPORATION, Tokyo (JP)

(72) Inventors: Kei ISHIMARU, Chino (JP); Yoshiyuki YAMAGUCHI, Matsumoto (JP); Kinya MATSUDA, Matsumoto (JP)

(21) Appl. No.: 19/256,580

(22) Filed: Jul. 1, 2025

(30) Foreign Application Priority Data
Jul. 2, 2024 (JP) 2024-106578

(51) Int. Cl. H02M 3/156; H02M 1/00

(52) U.S. Cl. CPC H02M 3/156; H02M 1/0009; H02M 1/0032

(57) ABSTRACT

A circuit device includes a control circuit configured to perform voltage mode control or hysteresis control and perform switching control on a switching element based on a result of the voltage mode control or the hysteresis control and a mode determination circuit configured to determine, based on an inductor current flowing to the inductor, a first mode in which the voltage mode control is performed and a second mode in which the hysteresis control is performed. The control circuit performs the switching control on the switching element based on the result of the voltage mode control when the mode determination circuit determines that a mode is the first mode. The control circuit performs the switching control on the switching element based on a result of the hysteresis control when the mode determination circuit determines that the mode is the second mode.

The present application is based on, and claims priority from JP Application Serial Number 2024-106578, filed Jul. 2, 2024, the disclosure of which is hereby incorporated by reference herein in its entirety.

### BACKGROUND

### 1. Technical Field

The present disclosure relates to a circuit device, a switching regulator, and the like.

### 2. Related Art

U.S. Patent Application Publication No. 2021/0083583 discloses a DCDC converter including an error amplifier that compares an output voltage and a reference voltage, a peak current comparator that compares a coil current and an output of the error amplifier to generate a peak detection voltage, an off-time timer circuit that generates an off-time signal for setting an off-time, a control logic that generates a signal for driving a power stage based on the peak detection voltage and the off-time signal, and a power stage.

U.S. Patent Application Publication No. 2021/0083583 is an example of the related art.

As a control scheme for a switching regulator, various schemes such as voltage mode control and hysteresis control are known. It is desirable to use a suitable scheme according to a load current of the switching regulator. For example, in U.S. Patent Application Publication No. 2021/0083583, feedback control is performed by one scheme and the scheme is not changed in response to a change in the load current.

### SUMMARY

An aspect of the present disclosure relates to a circuit device used for a switching regulator that outputs an output voltage obtained by regulating a power supply voltage with an inductor and a switching element that drives the inductor, the circuit device including: a control circuit configured to perform voltage mode control or hysteresis control for controlling the output voltage to a given constant voltage and perform switching control on the switching element based on a result of the voltage mode control or the hysteresis control; and a mode determination circuit configured to determine, based on an inductor current flowing to the inductor, a first mode in which the voltage mode control is performed and a second mode in which the hysteresis control is performed, wherein the control circuit performs the switching control on the switching element based on the result of the voltage mode control when the mode determination circuit determines that a mode is the first mode and performs the switching control on the switching element based on a result of the hysteresis control when the mode determination circuit determines that the mode is the second mode.

Another aspect of the present disclosure relates to a switching regulator including: the circuit device explained above; the switching element; and the inductor.

### BRIEF DESCRIPTION OF THE DRAWINGS

FIG. 1 is a configuration example of a switching regulator.

FIG. 2 is a diagram illustrating an operation of the switching regulator.

FIG. 3 is a detailed configuration example of a control circuit.

FIG. 4 is a truth table illustrating an operation of a pre-driver.

FIG. 5 is a diagram illustrating a first operation example of the switching regulator.

FIG. 6 is a diagram illustrating a second operation example of the switching regulator.

FIG. 7 is a diagram illustrating a third operation example of the switching regulator.

FIG. 8 is a detailed configuration example of a mode determination circuit.

FIG. 9 is a diagram illustrating an operation of the mode determination circuit.

FIG. 10 is a detailed configuration example of a current detection circuit.

FIG. 11 is a signal waveform example illustrating an operation of the current detection circuit at the time when a load current is relatively large and no reverse current is detected.

FIG. 12 is a signal waveform example illustrating an operation of the current detection circuit at the time when the load current is relatively small and a reverse current is detected.

FIG. 13 is a first detailed configuration example of a voltage mode control circuit and a hysteresis control circuit.

FIG. 14 is a first detailed configuration example of a pulse signal output circuit.

FIG. 15 is a detailed configuration example of an off-timer in the case in which the length of an off-time is variable.

FIG. 16 is a detailed configuration example of an on-timer.

FIG. 17 is a waveform example illustrating a continuous operation in a first mode, that is, voltage mode control.

FIG. 18 is a waveform example illustrating a discontinuous operation in the first mode, that is, the voltage mode control.

FIG. 19 is a waveform example illustrating a second mode, that is, hysteresis control.

FIG. 20 is an operation waveform example of the switching regulator at the time when a load current fluctuates.

FIG. 21 is an operation waveform example of the switching regulator at the time when the load current fluctuates.

FIG. 22 is a second detailed configuration example of the voltage mode control circuit and the hysteresis control circuit.

FIG. 23 is a second detailed configuration example of the pulse signal output circuit.

FIG. 24 is an operation waveform example of the switching regulator to which the second detailed configuration example is applied.

FIG. 25 is an operation waveform example of the switching regulator to which the second detailed configuration example is applied.

### DESCRIPTION OF EMBODIMENTS

Hereinafter, a preferred embodiment of the present disclosure is explained in detail. Note that the present embodiment explained below does not unduly limit the content described in the claims, and all of the components explained in the present embodiment are not always essential elements.

### 1. CONFIGURATION EXAMPLES

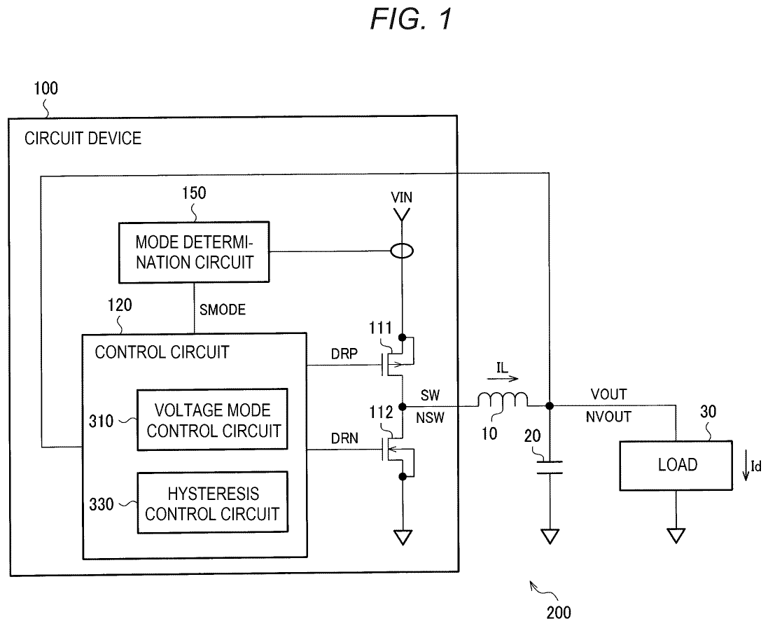

FIG. 1 is a configuration example of a switching regulator 200. The switching regulator 200 includes a circuit device 100, an inductor 10, and a capacitor 20. The switching regulator 200 is also called DCDC converter. The inductor 10 is also called coil.

The switching regulator 200 regulates a power supply voltage VIN to an output voltage VOUT and supplies the output voltage VOUT to a load 30. A not-illustrated power supply circuit is provided on the outside or the inside of the circuit device 100 and the power supply voltage VIN is supplied from the power supply circuit to the circuit device 100. The load 30 is, for example, a microcomputer that controls electronic equipment including the switching regulator 200 but is not limited thereto and may be various circuits.

The circuit device 100 includes a switching element 111, an N-type MOS transistor 112, a control circuit 120, and a mode determination circuit 150. The circuit device 100 is, for example, an integrated circuit device in which a plurality of circuit elements are integrated on a semiconductor substrate. FIG. 1 illustrates an example in which the switching element 111 and the N-type MOS transistor 112 are incorporated in the circuit device 100. However, those may be provided on the outside of the circuit device 100. FIG. 1 illustrates an example in which the inductor 10 and the capacitor 20 are provided on the outside of the circuit device 100. However, one or both of them may be built in the circuit device 100.

The switching element 111 is a P-type MOS transistor. A source of the switching element 111 is coupled to a node of the power supply voltage VIN and a drain thereof is coupled to a node NSW. A drive signal DRP from the control circuit 120 is input to a gate of the switching element 111. When the switching element 111 is on, the inductor 10 is driven by the power supply voltage VIN. The switching element 111 only has to be an element that can be switched by control from the control circuit 120 and may be, for example, an N-type MOS transistor or a bipolar transistor.

A source of the N-type MOS transistor 112 is coupled to a ground node and a drain thereof is coupled to the node NSW. A drive signal DRN from the control circuit 120 is input to a gate of the N-type MOS transistor 112. Here, an example in which the switching regulator 200 is a synchronous type is explained above. However, when the switching regulator 200 is an asynchronous type, a diode may be provided instead of the N-type MOS transistor. An anode of the diode may be coupled to the ground node and a cathode thereof may be coupled to the node NSW.

One end of the inductor 10 is coupled to the node NSW and the other end thereof is coupled to an output node NVOUT from which the output voltage VOUT is output. One end of the capacitor 20 is coupled to the output node NVOUT and the other end thereof is coupled to the ground node.

The mode determination circuit 150 determines a feedback control mode of the switching regulator based on an inductor current IL flowing to the inductor 10 and outputs a result of the determination as a mode signal SMODE. Modes include a first mode in which voltage mode control is performed and a second mode in which hysteresis control is performed. The mode determination circuit 150 determines a mode based on an electric current flowing to the switching element 111, that is, a drain current of the P-type MOS transistor, which is the switching element 111.

The output voltage VOUT is input to the control circuit 120. The control circuit 120 performs pulse modulation control on the drive signal DRP and the drive signal DRN such that the output voltage VOUT reaches a given constant voltage. Hereinafter, the given constant voltage is sometimes referred to as target voltage. The control circuit 120 includes a voltage mode control circuit 310 that performs pulse modulation control according to voltage mode control and a hysteresis control circuit 330 that performs pulse modulation control according to hysteresis control. When the mode signal SMODE is a signal indicating the first mode, the control circuit 120 outputs the drive signal DRP and the drive signal DRN based on an output signal of the voltage mode control circuit 310. When the mode signal SMODE is a signal indicating the second mode, the control circuit 120 outputs the drive signal DRP and the drive signal DRN based on an output signal of the hysteresis control circuit 330.

The voltage mode control is a method of not using the inductor current IL for generation of a slope voltage and comparing an error voltage indicating the error between the output voltage VOUT and the given constant voltage and the slope voltage to control an on-time of the switching element 111. The hysteresis control is a method of comparing the output voltage VOUT and the given constant voltage using a comparator and controlling the switching element 111 using a result of the comparison. The on-time may be constant or may be controlled by hysteresis of the comparator.

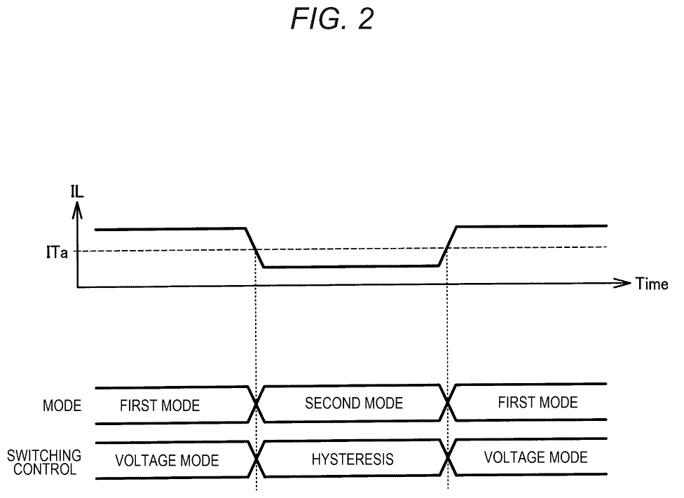

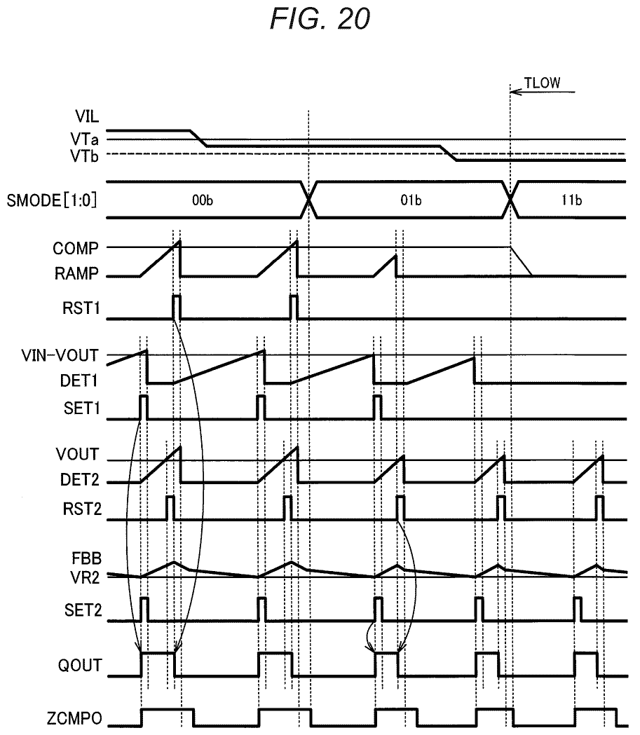

FIG. 2 is a diagram illustrating an operation of the switching regulator 200 illustrated in FIG. 1. The mode determination circuit 150 compares the inductor current IL and a first threshold ITa. The mode determination circuit 150 determines that the mode is the first mode when the inductor current IL is equal to or larger than the first threshold ITa and determines that the mode is the second mode when the inductor current IL is smaller than the first threshold ITa. The mode determination circuit 150 may switch the mode immediately after the inductor current IL falls below or exceeds the first threshold ITa or may switch the mode at predetermined timing after the inductor current IL falls below or exceeds the first threshold ITa as explained below with reference to FIG. 20 and the like. In the present embodiment, the circuit device 100 is used in the switching regulator 200. The switching regulator 200 outputs the output voltage VOUT obtained by regulating the power supply voltage VIN with the inductor 10 and the switching element 111 that drives the inductor 10. The circuit device 100 includes the control circuit 120 and the mode determination circuit 150. The control circuit 120 performs voltage mode control or hysteresis control for controlling the output voltage VOUT to a given constant voltage and performs switching control on the switching element 111 based on a result of the voltage mode control or the hysteresis control. The mode determination circuit 150 determines, based on the inductor current IL flowing to the inductor 10, a first mode in which the voltage mode control is performed and a second mode in which the hysteresis control is performed. When the mode determination circuit 150 determines that the mode is the first mode, the control circuit 120 performs switching control on the switching element 111 based on a result of the voltage mode control. When the mode determination circuit 150 determines that the mode is the second mode, the control circuit 120 performs switching control on the switching element 111 based on a result of the hysteresis control.

According to the present embodiment, the switching regulator 200 includes a feedback path by the voltage mode control and a feedback path by the hysteresis control. The voltage mode control and the hysteresis control are switched according to a mode determination result based on the inductor current IL. Accordingly, it is possible to switch to a control scheme to a suitable feedback scheme according to the load current Id of the switching regulator 200.

In the present embodiment, the mode determination circuit 150 may compare the inductor current IL and the first threshold ITa. The mode determination circuit 150 may determine that the mode is the first mode when the inductor current IL is equal to or larger than the first threshold ITa and determine that the mode is the second mode when the inductor current IL is smaller than the first threshold ITa.

According to the present embodiment, the voltage mode control is selected when the inductor current IL is equal to or larger than the first threshold ITa and the hysteresis control is selected when the inductor current IL is smaller than the first threshold ITa. In this way, appropriate feedback control is selected according to the load current Id. As explained below, by switching the control, it is possible to stop a circuit not in use to thereby reduce power consumption. For example, since the hysteresis control circuit 330 includes fewer components compared with the voltage mode control circuit 310 and can reduce power consumption, the power consumption at the time of a low load can be reduced by changing the voltage mode control circuit 310 to low power setting in the hysteresis control. At the time of the low load, the power consumption of the switching regulator 200 is a factor that reduces the power efficiency but the power efficiency can be improved by reducing the power consumption.

### 2. DETAILED CONFIGURATION EXAMPLES

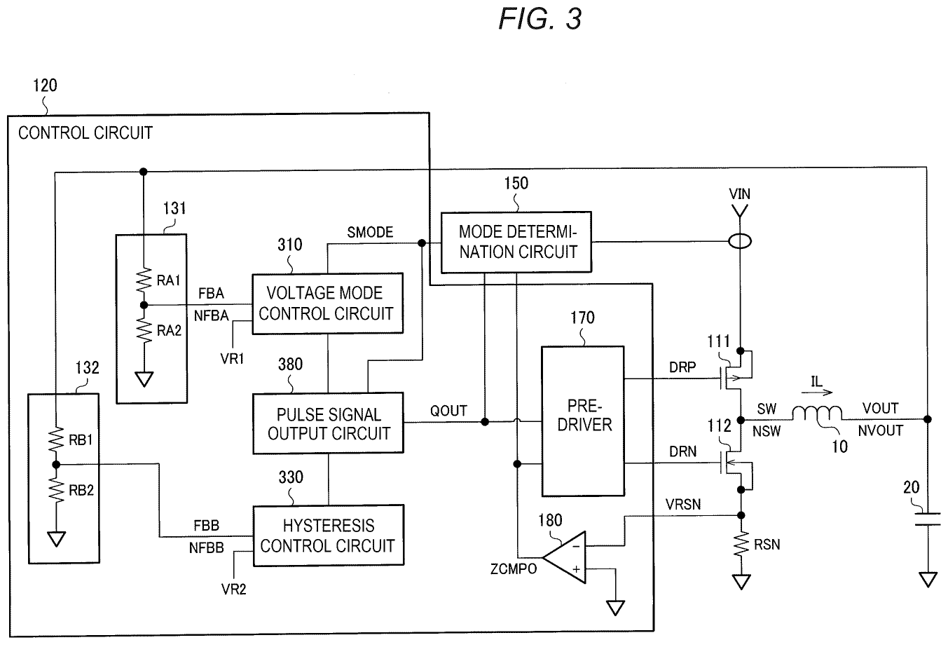

FIG. 3 is a detailed configuration example of the control circuit 120. The control circuit 120 includes a first voltage divider circuit 131, a second voltage divider circuit 132, the mode determination circuit 150, a pre-driver 170, a reverse current detection circuit 180, the voltage mode control circuit 310, the hysteresis control circuit 330, and a pulse signal output circuit 380.

The first voltage divider circuit 131 divides the output voltage VOUT and outputs a first feedback voltage FBA, which is a result of the division, to a node NFBA. The first voltage divider circuit 131 includes a resistor RA1 and a resistor RA2. One end of the resistor RA1 is coupled to the output node NVOUT, and the other end thereof is coupled to the node NFBA. One end of the resistor RA2 is coupled to the node NFBA and the other end thereof is coupled to the ground node. A voltage division ratio is RA2/(RA1+RA2) and FBA=VOUT×(RA2/(RA1+RA2)).

The voltage mode control circuit 310 performs voltage mode control to cause the first feedback voltage FBA to coincide with a first reference voltage VR1 to control the output voltage VOUT to be the target voltage. The target voltage is the output voltage VOUT satisfying VR1=VOUT×(RA2/(RA1+RA2)).

The second voltage divider circuit 132 divides the output voltage VOUT and outputs a second feedback voltage FBB, which is a result of the division, to a node NFBB. The second voltage divider circuit 132 includes a resistor RB1 and a resistor RB2. One end of the resistor RB1 is coupled to the output node NVOUT, and the other end thereof is coupled to the node NFBB. One end of the resistor RB2 is coupled to the node NFBB and the other end thereof is coupled to the ground node. A voltage division ratio is RB2/(RB1+RB2) and FBB=VOUT×(RB2/(RB1+RB2)).

The hysteresis control circuit 330 performs the hysteresis control to cause the second feedback voltage FBB to coincide with a second reference voltage VR2 to control the output voltage VOUT to be the target voltage. The target voltage is the output voltage VOUT satisfying VR2=VOUT×(RB2/(RB1+RB2)).

The first reference voltage VR1, the second reference voltage VR2, the voltage division ratio of the first voltage divider circuit 131, and the voltage division ratio of the second voltage divider circuit 132 are set such that the target voltage of the voltage mode control and the target voltage of the hysteresis control are the same. For example, the first reference voltage VR1 and the second reference voltage VR2 may be equal. At this time, the voltage division ratio of the first voltage divider circuit 131 and the voltage division ratio of the second voltage divider circuit 132 may be the same. The voltage division ratio of the first voltage divider circuit 131 and the voltage division ratio of the second voltage divider circuit 132 may be variable. For example, each of the resistor RA2 and the resistor RB2 may be a variable resistor. At this time, the circuit device 100 may include a not-illustrated register in which a resistance value of the variable resistor is set. A resistance value of each of the resistor RA2 and the resistor RB2 may be set based on the set value. The first reference voltage VR1 and the second reference voltage VR2 may be supplied from, for example, a not-illustrated voltage generation circuit provided in the circuit device 100 or may be supplied from the outside of the circuit device 100.

When the mode signal SMODE indicates the first mode, the pulse signal output circuit 380 outputs a pulse signal QOUT based on the output signal of the voltage mode control circuit 310. The pulse signal QOUT is a signal indicating ON or OFF of the switching element 111 and, in the first mode, is a signal pulse-modulated by the voltage mode control. When the mode signal SMODE indicates the second mode, the pulse signal output circuit 380 outputs the pulse signal QOUT based on an output signal of the hysteresis control circuit 330. In the second mode, the pulse signal QOUT is a signal pulse-modulated by the hysteresis control.

The reverse current detection circuit 180 detects a reverse current of the inductor current IL flowing to the inductor 10. Specifically, a sense resistor RSN is provided between the source of the N-type MOS transistor 112 and the ground node. The reverse current detection circuit 180 is a comparator. The comparator compares a voltage VRSN at one end of the sense resistor RSN and the ground voltage and outputs a result of the comparison as a reverse current detection signal ZCMPO. FIG. 3 illustrates an example in which the voltage VRSN is input to a negative input terminal of the comparator, which is a reverse current detection circuit, and the ground voltage is input to a positive input terminal. When VRSN<0 V, the reverse current detection signal ZCMPO at a high level is output. When the inductor current IL flows backward, since VRSN≥0 V, the reverse current detection signal ZCMPO at a low level is output. When the pulse signal QOUT is at the high level, the reverse current detection circuit 180 may disable the reverse current detection and output the reverse current detection signal ZCMPO at the high level.

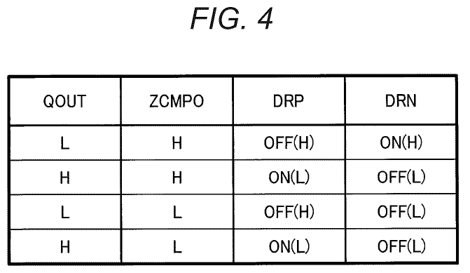

The pre-driver 170 performs switching control on the switching element 111 and the N-type MOS transistor 112 based on the pulse signal QOUT and the reverse current detection signal ZCMPO. FIG. 4 is a truth table illustrating an operation of the pre-driver 170. In FIG. 4, “L” indicates the low level and “H” indicates the high level. Concerning the drive signal DRP relating to on/off of the switching element 111 and the drive signal DRN relating to on/off of the N-type MOS transistor 112, ON or OFF and a logic level are described together like “OFF (H)” or the like.

When the reverse current detection signal ZCMPO is at the high level, that is, when a reverse current is not detected, the pre-driver 170 exclusively turns on or off the switching element 111 and the N-type MOS transistor 112 according to the pulse signal QOUT. That is, the pre-driver 170 turns off the switching element 111 and turns on the N-type MOS transistor 112 when the pulse signal QOUT is at the low level. The pre-driver 170 turns on the switching element 111 and turns off the N-type MOS transistor 112 when the pulse signal QOUT is at the high level. When the reverse current detection signal ZCMPO is at a low level, that is, when a reverse current is detected, the pre-driver 170 turns on or off the switching element 111 according to a logic level of the pulse signal QOUT and turns off the N-type MOS transistor 112 regardless of the logic level of the pulse signal QOUT. The pre-driver 170 turns off the switching element 111 when the pulse signal QOUT is at the low level and turns on the switching element 111 when the pulse signal QOUT is at the high level.

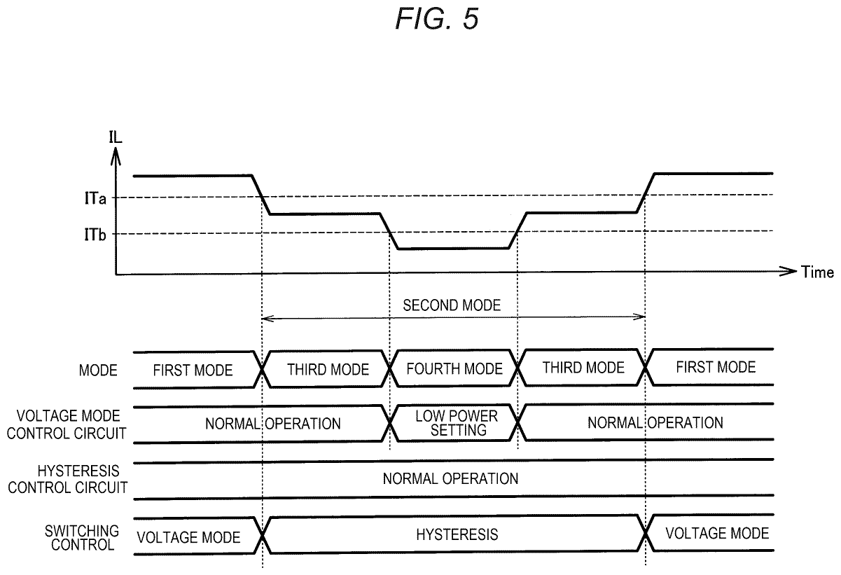

FIG. 5 is a diagram illustrating a first operation example of the switching regulator 200 using the control circuit 120 illustrated in FIG. 3. In the present operation example, the voltage mode control circuit 310 changes to the low power setting in a part of a period of the second mode. The low power setting means that some or all of circuits stop or are in a low power consumption state. The stop means that an operation is stopped by stop of supply of electric power or a bias current. The low power consumption state is a state in which power consumption is reduced by reduction, partial stop, or the like of the bias current.

The second mode in which the hysteresis control is performed is divided into a third mode and a fourth mode according to the inductor current IL. Specifically, the mode determination circuit 150 compares the inductor current IL and a second threshold ITb smaller than the first threshold ITa. The mode determination circuit 150 determines that the mode is the third mode when the inductor current IL is smaller than the first threshold ITa and equal to or larger than the second threshold ITb and determines that the mode is the fourth mode when the inductor current IL is smaller than the second threshold ITb. The voltage mode control circuit 310 performs a normal operation in the first mode and the third mode and changes to the low power setting in the fourth mode. The hysteresis control circuit 330 performs a normal operation in all of the first mode, the third mode, and the fourth mode.

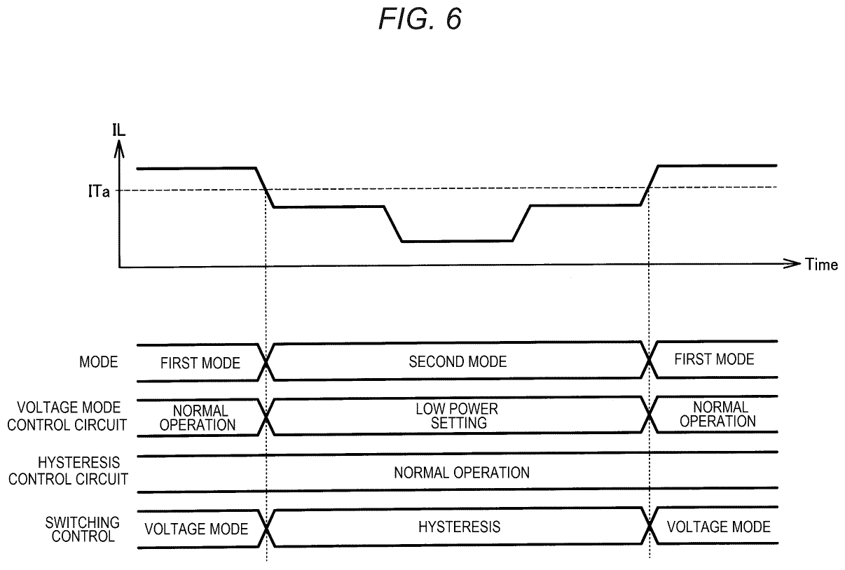

FIG. 6 is a diagram illustrating a second operation example of the switching regulator 200 using the control circuit 120 illustrated in FIG. 3. In the present operation example, the voltage mode control circuit 310 changes to the low power setting in the entire period of the second mode. In the present operation example, the third mode and the fourth mode may not be provided.

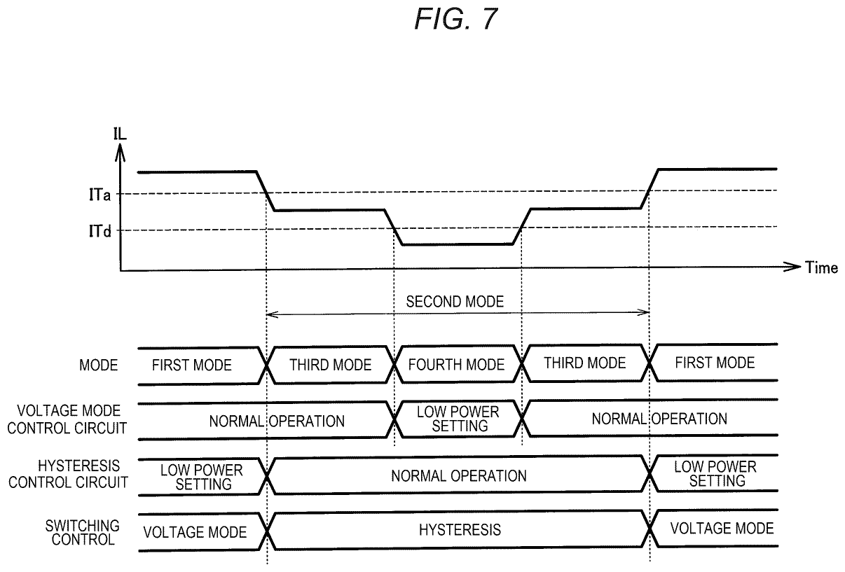

FIG. 7 is a diagram illustrating a third operation example of the switching regulator 200 using the control circuit 120 illustrated in FIG. 3. In the present operation example, the hysteresis control circuit 330 changes to the low power setting in the first mode. The voltage mode control circuit 310 changes to the low power setting in, for example, the fourth mode. Alternatively, the voltage mode control circuit 310 may change to the low power setting in the entire period of the second mode as illustrated in FIG. 6 or may perform the normal operation in all the modes.

By changing, of the voltage mode control circuit 310 and the hysteresis control circuit 330, the circuit not selected by the mode to the low power setting as explained above, a power loss of the switching regulator 200 can be reduced. Since the power loss can be reduced, power efficiency of the switching regulator 200 can be improved. In particular, since supply power to the load is small when the load current Id is small, the power loss of the switching regulator 200 is likely to significantly reduce the power efficiency. In the present embodiment, the hysteresis control is selected when the load current Id is small. The voltage mode control circuit 310 not used at that time is set to the low power. Accordingly, the power efficiency at the time of the low load can be improved.

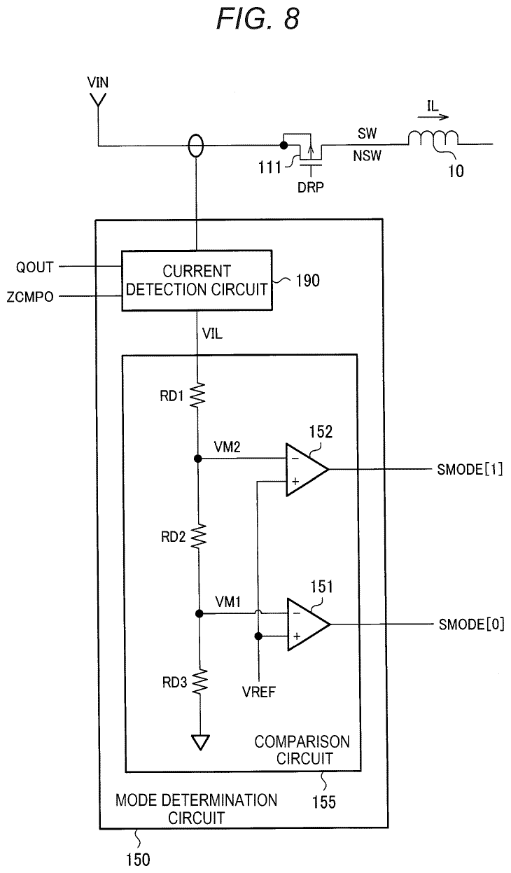

FIG. 8 is a detailed configuration example of the mode determination circuit 150. The mode determination circuit 150 includes a current detection circuit 190 and a comparison circuit 155. Here, an example in which the mode determination circuit 150 outputs a 2-bit mode signal SMODE [1:0] is indicated. The current detection circuit 190 may be provided on the outside of the circuit device 100. In that case, the mode determination circuit 150 may include only the comparison circuit 155.

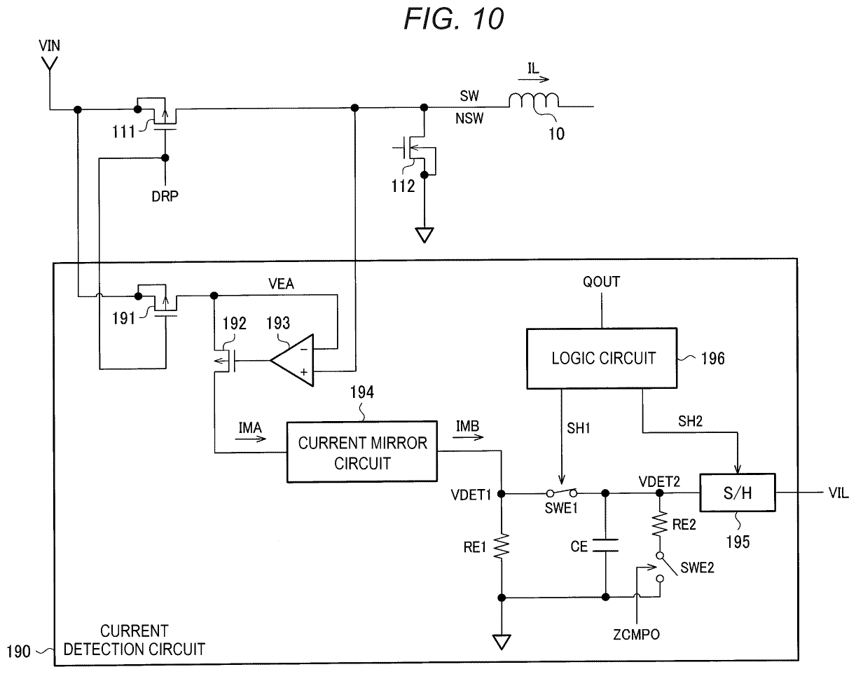

The current detection circuit 190 detects the inductor current IL and outputs a result of the detection as the voltage VIL. The voltage VIL is a voltage that rises when the inductor current IL increases. Since the inductor current IL changes according to the load current Id, the voltage VIL can also be considered a voltage corresponding to the load current Id. The current detection circuit 190 converts a drain current of the switching element 111 into a voltage, peak-holds the voltage based on the pulse signal QOUT, and outputs the voltage VIL based on the peak-held voltage. The current detection circuit 190 reduces the peak-held voltage based on the reverse current detection signal ZCMPO to more accurately reflect the load current Id on the voltage VIL. Details of the current detection circuit 190 are explained below with reference to FIG. 10. The comparison circuit 155 includes resistors RD1 to RD3 and comparators 151 and 152. The resistors RD1 to RD3 are coupled in series between the node of the voltage VIL and the ground node and output voltages VM1 and VM2 obtained by dividing the voltage VIL. The voltage VM1 is lower than the voltage VM2. The comparator 151 compares the voltage VM1 and the reference voltage VREF and outputs a result of the comparison as a bit SMODE [0] of a mode signal. FIG. 8 illustrates an example in which the reference voltage VREF is input to a positive input terminal of the comparator 151 and the voltage VM1 is input to a negative input terminal thereof. In this case, the comparator 151 outputs a low level bit SMODE [0] when VM1≥VREF and outputs a high level bit SMODE [0] when VM1<VREF. The comparator 152 compares the voltage VM2 and the reference voltage VREF and outputs a result of the comparison as a bit SMODE [1] of a mode signal. FIG. 8 illustrates an example in which the reference voltage VREF is input to the positive input terminal of the comparator 151 and the voltage VM2 is input to the negative input terminal thereof. In this case, the comparator 152 outputs a low level bit SMODE [1] when VM2≥VREF and outputs a high level bit SMODE [1] when VM2<VREF.

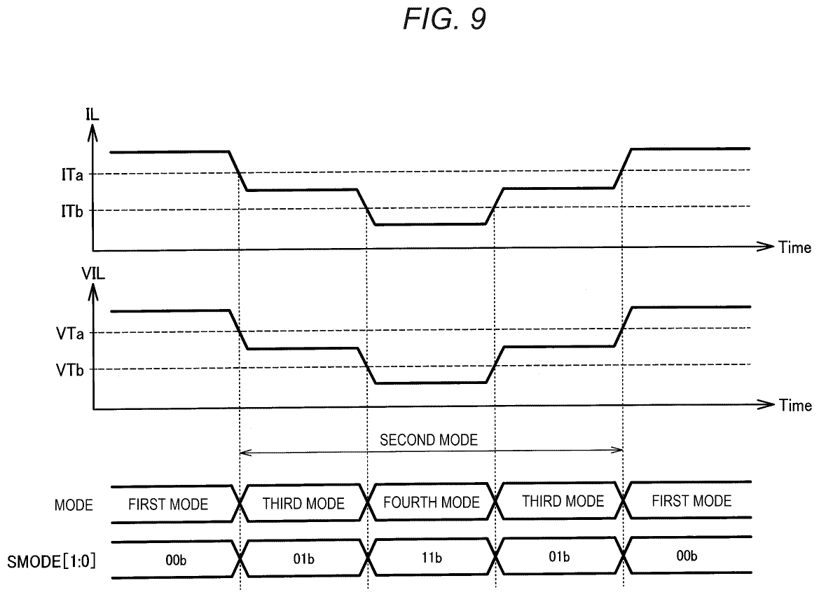

FIG. 9 is a diagram illustrating an operation of the mode determination circuit 150 illustrated in FIG. 8. A first threshold voltage VTa and a second threshold voltage VTb for the voltage VIL respectively correspond to the first threshold ITa and the second threshold ITb for the inductor current IL. In correspondence with FIG. 8, VIL=VTa is equivalent to VM1=VREF and VIL=VTb is equivalent to VM2=VREF. The comparison circuit 155 outputs a mode signal SMODE [1:0]=00b indicating the first mode when IL≥ITa, that is, VIL>VTa. b at the end of 00b indicates that 00 is a binary number. The comparison circuit 155 outputs a mode signal SMODE [1:0]=01b indicating the third mode when ITa>IL≥ITb, that is, VTa>VIL≥VTb. The comparison circuit 155 outputs a mode signal SMODE [1:0]=11b indicating the fourth mode when ITb>IL, that is, VTb>VIL.

FIG. 10 is a detailed configuration example of the current detection circuit 190. The current detection circuit 190 includes a current mirror transistor 191, a P-type MOS transistor 192, an error amplifier 193, a current mirror circuit 194, a sample hold circuit 195, a logic circuit 196, switches SWE1 and SWE2, resistors RE1 and RE2, and a capacitor CE.

The current mirror transistor 191 is a transistor of the same conductivity type as the switching element 111 and, here, is a P-type MOS transistor. A source of the current mirror transistor 191 is coupled to the node of the power supply voltage VIN and a drain thereof is coupled to a negative input terminal of the error amplifier 193. The drive signal DRP is input to a gate of the current mirror transistor 191. A positive input terminal of the error amplifier 193 is coupled to the node NSW and an output terminal thereof is coupled to a gate of the P-type MOS transistor 192. A source of the P-type MOS transistor 192 is coupled to the negative input terminal of the error amplifier 193.

The error amplifier 193 controls a gate voltage of the P-type MOS transistor 192 to cause a voltage VEA of a drain of the current mirror transistor 191 to coincide with a voltage SW of the node NSW. Accordingly, the current mirror transistor 191 mirrors an electric current flowing to the switching element 111. A mirrored current IMA is obtained by mirroring the inductor current IL at the time when the switching element 111 is on and is output from a drain of the P-type MOS transistor 192.

The current mirror circuit 194 mirrors the current IMA and outputs the current IMA as a current IMB. The resistor RE1 is provided between an output node of the current mirror circuit 194 and the ground node and converts the current IMB into a voltage VDET1. The switch SWE1 is coupled between the output node of the current mirror circuit 194 and an input node of the sample hold circuit 195. The capacitor CE is coupled between the input node of the sample hold circuit 195 and the ground node. The resistor RE2 and the switch SWE2 are coupled in series between the input node of the sample hold circuit 195 and the ground node.

The logic circuit 196 outputs signals SH1 and SH2 corresponding to edges of the pulse signal QOUT. The signal SH1 corresponds to an edge of the pulse signal QOUT at the time when the switching element 111 changes from ON to OFF. The signal SH2 corresponds to an edge of the pulse signal QOUT at the time when the switching element 111 changes from OFF to ON. The switch SWE1 is controlled to be turned on or off by a signal SH1. The sample hold circuit 195 samples and holds a voltage VDET2 of the input node based on the signal SH2 and outputs a result of the sample hold as the voltage VIL. The switch SWE2 is controlled to be turned on or off based on the reverse current detection signal ZCMPO. The logic circuit 196 may be provided in the pulse signal output circuit 380 or the pre-driver 170.

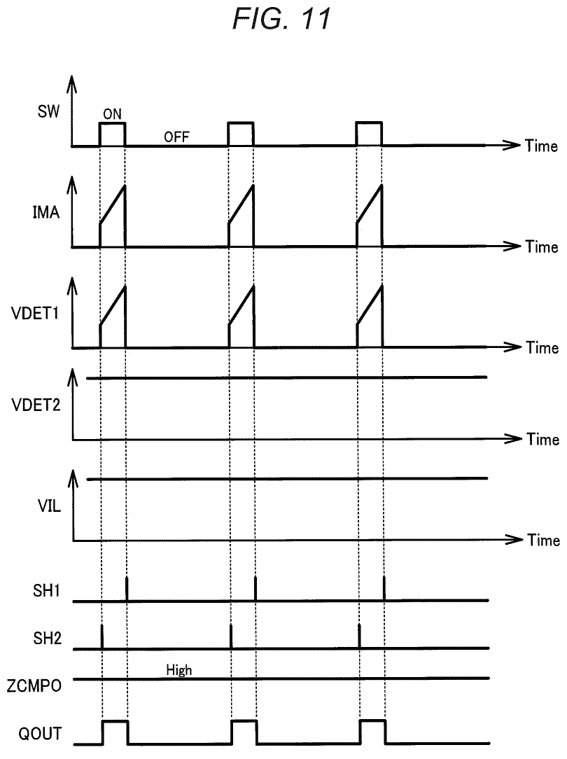

FIG. 11 is a signal waveform example for explaining an operation of the current detection circuit 190 at the time when the load current Id is relatively large and a reverse current is not detected.

When the switching element 111 is on, the current IMA corresponding to the inductor current IL flows. The current IMA is converted into the voltage VDET1 by the resistor RE1. When the switching element 111 changes from ON to OFF, the signal SH1 changes to the high level and the switch SWE1 is turned on. The signal SH1 immediately changes to the low level and the switch SWE1 is turned off. At this time, a peak voltage of the voltage VDET1 is held in the capacitor CE as the voltage VDET2. The reverse current detection signal ZCMPO is at the high level and the switch SWE2 is off. For this reason, the voltage VDET2 is maintained until the signal SH1 changes to the high level next time. When the switching element 111 changes from OFF to ON, the signal SH2 changes to the high level and the sample hold circuit 195 samples the voltage VDET2 and outputs the voltage VDET2 as the voltage VIL. The signal SH2 immediately changes to the low level and the sample hold circuit 195 holds the voltage VIL.

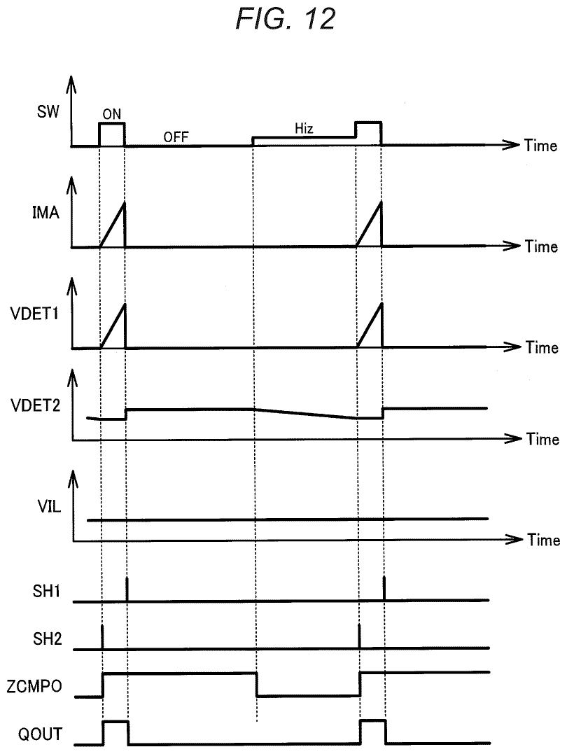

FIG. 12 is a signal waveform example illustrating an operation of the current detection circuit 190 at the time when the load current Id is relatively small and a reverse current is detected.

The operation until the voltage VDET1 is held as the voltage VDET2 in the capacitor CE by the signal SH1 is the same as the operation illustrated in FIG. 11. Thereafter, when a reverse current is detected and the reverse current detection signal ZCMPO changes to the low level, the switch SWE2 is turned on. Electric charges held in the capacitor CE are discharged to the ground via the resistor RE2 and the switch SWE2, whereby the voltage VDET2 gradually drops. When the switching element 111 changes from OFF to ON, the signal SH2 changes to the high level and the sample hold circuit 195 samples the voltage VDET2 and outputs the voltage VDET2 as the voltage VIL. The signal SH2 immediately changes to the low level and the sample hold circuit 195 holds the voltage VIL.

As the load current Id is smaller, an ON interval of the switching element 111 is longer, that is, a period in which the reverse current detection signal ZCMPO is at the low level is longer. For this reason, the voltage VDET2 further drops as the load current Id is smaller. The voltage VDET2 is sampled and held by the sample hold circuit 195. Accordingly, in the case of a low load, the voltage VIL reflecting a current value of the load current Id can be more accurately obtained, that is, more accurate current detection can be performed.

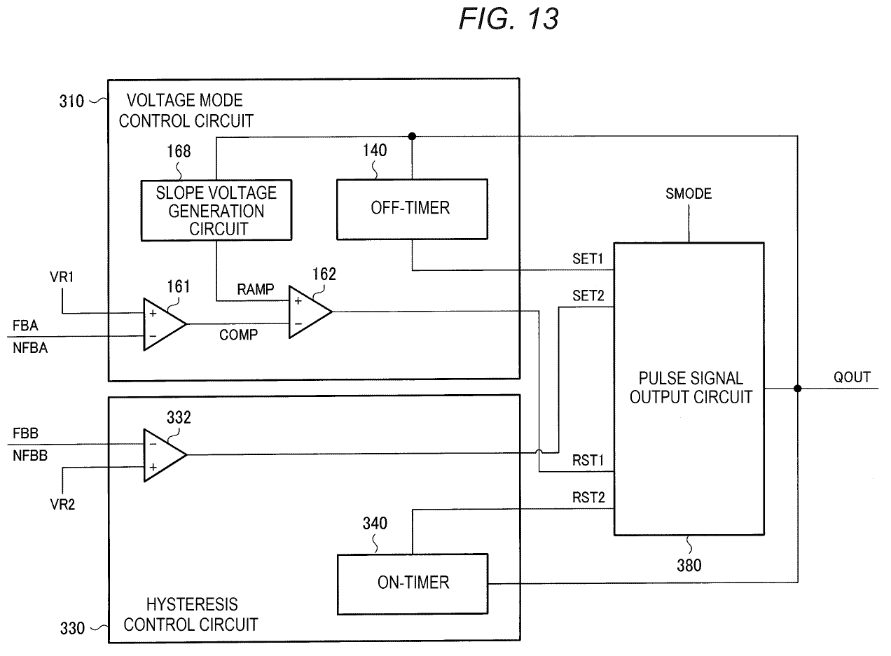

FIG. 13 is a first detailed configuration example of the voltage mode control circuit 310 and the hysteresis control circuit 330.

The voltage mode control circuit 310 includes an error amplifier 161, a first comparator 162, a slope voltage generation circuit 168, and an off-timer 140.

The error amplifier 161 amplifies the error between the first feedback voltage FBA and the first reference voltage VR1 and outputs a result of the amplification as an error voltage COMP. FIG. 13 illustrates an example in which the first feedback voltage FBA is input to a negative input terminal of the error amplifier 161 and the first reference voltage VR1 is input to a positive input terminal thereof. In this case, the error amplifier 161 drops the error voltage COMP when FBA>VR1 and raises the error voltage COMP when FBA<VR1. The error amplifier 161 is an integration circuit that integrates the difference between the first feedback voltage FBA and the first reference voltage VR1 and includes, for example, an operational amplifier and an integration capacitor. The first reference voltage VR1 is input to a positive input terminal of the operational amplifier, the first feedback voltage FBA is input to a negative input terminal of the operational amplifier, and a voltage difference between an output terminal and the negative input terminal of the operational amplifier is fed back by the integration capacitor.

The first feedback voltage FBA output by the first voltage divider circuit 131 is controlled to be close to the first reference voltage VR1 by virtual short of the operational amplifier and fluctuation in the output voltage VOUT is not directly reflected on the first feedback voltage FBA. In this regard, by providing the second voltage divider circuit 132 anew as illustrated in FIG. 3, the fluctuation in the output voltage VOUT is directly reflected on the second feedback voltage FBB. Accordingly, the fluctuation in the output voltage VOUT is appropriately transmitted to the hysteresis control circuit 330.

The slope voltage generation circuit 168 generates a slope voltage RAMP, which rises with elapse of time, when the pulse signal QOUT is at the high level and resets the slope voltage RAMP when the pulse signal QOUT is at the low level. The slope voltage is also called a triangular wave. The reset of the slope voltage RAMP means the slope voltage RAMP being initialized to an initial voltage of the slope voltage RAMP, that is, a voltage at which a slope is started.

The first comparator 162 compares the error voltage COMP and the slope voltage RAMP and outputs a result of the comparison as a first reset signal RST1. FIG. 13 illustrates an example in which the error voltage COMP is input to the negative input terminal of the first comparator 162 and the slope voltage RAMP is input to the positive input terminal thereof.

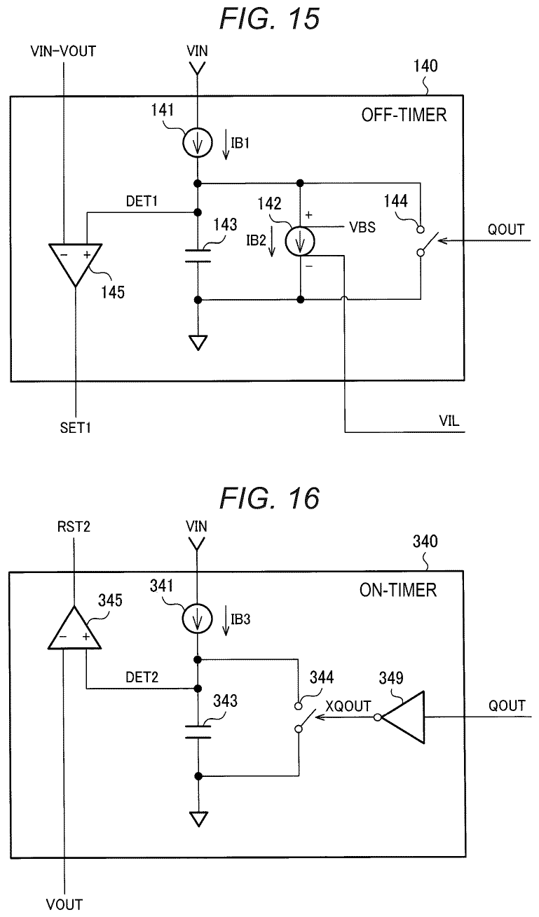

The off-timer 140 starts a timer when the pulse signal QOUT changes from the high level to the low level, that is, when the switching element 111 changes from ON to OFF. When the off-timer 140 measures elapse of an off-time, the off-timer 140 changes the first set signal SET1 from the low level to the high level. Accordingly, as explained below, the pulse signal QOUT changes from the low level to the high level and, in response to that, the off-timer 140 resets the timer and changes the first set signal SET1 from the high level to the low level. The off-time measured by the off-timer 140 is a period for setting the length of a time in which the switching element 111 is off. The length of the off-time may be fixed or may be variably controlled according to the inductor current IL as explained below with reference to FIG. 15.

The hysteresis control circuit 330 includes a second comparator 332 and an on-timer 340.

The second comparator 332 compares the second feedback voltage FBB and the second reference voltage VR2 and outputs a result of the comparison as a second set signal SET2. FIG. 13 illustrates an example in which the second feedback voltage FBB is input to a negative input terminal of the second comparator 332 and the second reference voltage VR2 is input to a positive input terminal thereof.

The on-timer 340 starts a timer when the pulse signal QOUT changes from the low level to the high level, that is, when the switching element 111 changes from OFF to ON. The on-timer 340 changes the second reset signal RST2 from the low level to the high level when measuring elapse of the on-time. Accordingly, as is explained below, the pulse signal QOUT changes from the high level to the low level and, in response to that, the on-timer 340 resets the timer and changes the second reset signal RST2 from the high level to the low level. The on-time measured by the on-timer 340 is a period for setting the length of a time in which the switching element 111 is on.

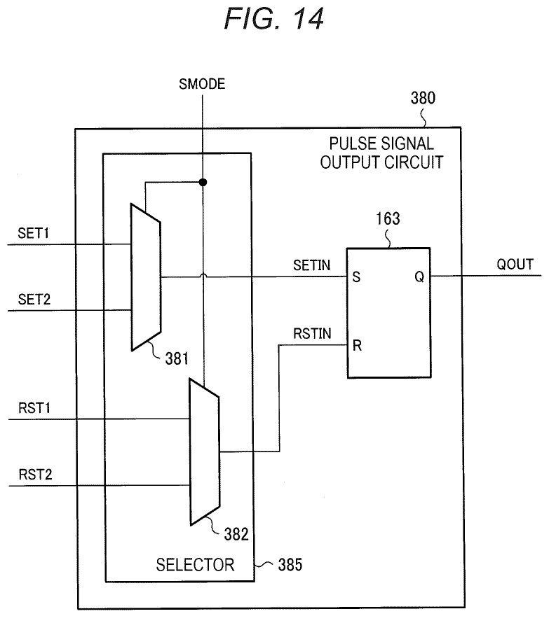

FIG. 14 is a first detailed configuration example of the pulse signal output circuit 380. The pulse signal output circuit 380 includes a selector 385 and an RS latch circuit 163.

The selector 385 selects, based on the mode signal SMODE, the first set signal SET1 and the first reset signal RST1 or the second set signal SET2 and the second reset signal RST2 as a set signal SETIN and a reset signal RSTIN of the RS latch circuit 163. Specifically, the selector 385 includes a first selector 381 and a second selector 382. In the first mode, the first selector 381 selects the first set signal SET1 as the set signal SETIN and the second selector 382 selects the first reset signal RST1 as the reset signal RSTIN. In the second mode, the first selector 381 selects the second set signal SET2 as the set signal SETIN and the second selector 382 selects the second reset signal RST2 as the reset signal RSTIN.

The RS latch circuit 163 outputs the pulse signal QOUT based on the set signal SETIN and the reset signal RSTIN selected by the selector 385.

FIG. 15 is a detailed configuration example of the off-timer 140 in the case in which the length of the off-time is variable.

The off-timer 140 includes a current source 141, a variable current source 142, a capacitor 143, a switch 144, and a comparator 145. When the length of the off-time is fixed, the variable current source 142 may be omitted.

When the pulse signal QOUT is at the high level, that is, when the switching element 111 is on, the switch 144 is on. At this time, since both ends of the capacitor 143 are short-circuited to the ground, the voltage DET1 drops to 0 V. Since VIN−VOUT>0 V in a step-down DCDC converter, the comparator 145 outputs the first set signal SET1 at the low level.

When the pulse signal QOUT is at the low level, that is, when the switching element 111 is off, the switch 144 is off. A capacitance value of the capacitor 143 is described as Coff. An output current IB1 of the current source 141 is described as VIN/Roff. An output current IB2 of the variable current source 142 is 0 A when VIL≥VBS and is g2×(VBS−VIL) when VIL<VBS. VBS is a bias voltage supplied from a not-illustrated voltage generation circuit. g2 is a coefficient of voltage-current conversion in the variable current source 142. At this time, the voltage DET1 is charged by an electric current (IB1−IB2) and rises. When DET1>VIN−VOUT, the comparator 145 changes the first set signal SET1 from the low level to the high level. Accordingly, the pulse signal QOUT changes from the low level to the high level.

A time when the pulse signal QOUT is at the low level is the off-time. When the off-time is represented as Toff, Toff=Coff×(VIN−VOUT)/(IB1−IB2). When the load current Id is large, the inductor current IL increases and the voltage VIL rises. When VIL≥VBS, IB2=0 A and, at this time, Toff=(1−VOUT/VIN)×Roff×Coff. The length of the off-time Toff is constant regardless of the inductor current IL. In the sense that only the on-time is controlled, this is equivalent to PWM control. When the load current Id is small, the inductor current IL decreases and the voltage VIL drops. When VIL<VBS, IB2=g2×(VBS−VIL). Since the voltage VIL drops and the electric current IB2 increases as the inductor current IL decreases, the length of the off-time Toff increases. In the sense that the off-time is controlled according to the inductor current IL, this is equivalent to PFM control.

FIG. 16 is a detailed configuration example of the on-timer 340. The on-timer 340 includes a current source 341, a capacitor 343, a switch 344, a comparator 345, and an inverter 349.

The inverter 349 inverts a logic level of the pulse signal QOUT and outputs a result of the inversion as a signal XQOUT. The switch 344 is controlled to be turned on or off based on the signal XQOUT.

When the pulse signal QOUT is at a low level, that is, when the switching element 111 is off, the switch 344 is off. At this time, since both ends of the capacitor 343 are short-circuited to the ground, the voltage DET2 drops 0 V. Since VOUT>0 V, the comparator 345 outputs the second reset signal RST2 at the low level.

When the pulse signal QOUT is at the high level, that is, when the switching element 111 is on, the switch 344 is off. A capacitance value of the capacitor 343 is described as Con. An output current IB3 of the current source 341 is described as VIN/Ron. At this time, the voltage DET2 is charged by the electric current IB3 and rises. When DET2>VOUT, the comparator 345 changes the second reset signal RST2 from the low level to the high level. Accordingly, the pulse signal QOUT changes from the high level to the low level. A time when the pulse signal QOUT is at the high level is the on-time. When the on-time is Ton, Ton=Con×VOUT/IB3.

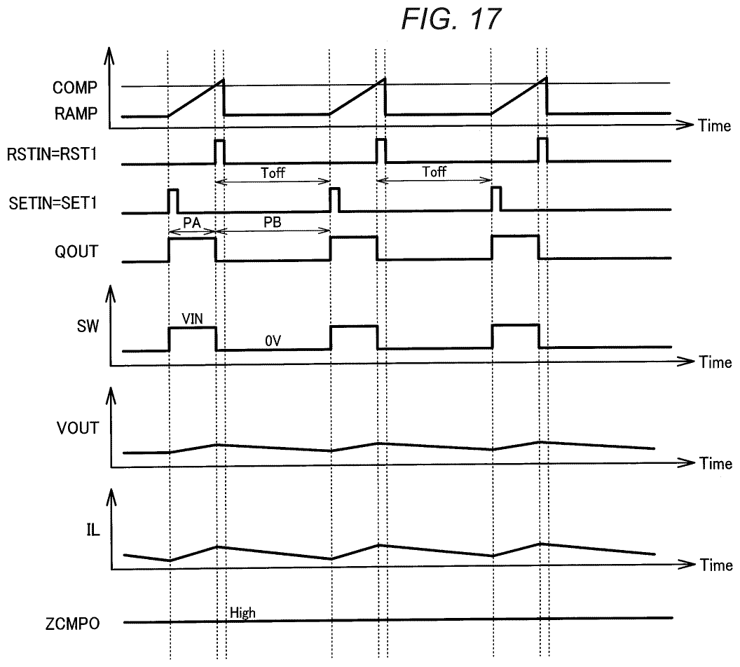

FIG. 17 is a waveform example illustrating a continuous operation in the first mode, that is, the voltage mode control. Here, it is assumed that the load current Id does not fluctuate. The continuous operation is an operation in the case in which the load current Id is relatively large and a reverse current of the inductor current IL does not occur. Since a reverse current does not occur, the reverse current detection signal ZCMPO is at the high level.

A period PA is a period in which the switching element 111 is on and the N-type MOS transistor 112 is off. In the period PA, the voltage SW of the node NSW reaches the power supply voltage VIN, the inductor current IL increases, and the output voltage VOUT rises. A period PB is a period in which the switching element 111 is off and the N-type MOS transistor 112 is on. In the period PB, the voltage SW of the node NSW drops to 0 V, the inductor current IL decreases, and the output voltage VOUT drops. In the continuous operation, the period PA and the period PB constitute one cycle of switching. Fluctuation in the output voltage VOUT and the inductor current IL due to the switching is so-called ripple.

In the continuous operation, the off-time Toff is equivalent to the period PB. When the off-time Toff ends, the off-timer 140 changes the first set signal SET1 from the low level to the high level. In response to this, the RS latch circuit 163 changes the pulse signal QOUT from the low level to the high level. In response to this, the off-timer 140 changes the first set signal SET1 from the high level to the low level and the slope voltage generation circuit 168 starts generating the slope voltage RAMP. When the slope voltage RAMP reaches the error voltage COMP, the first comparator 162 changes the first reset signal RST1 from the low level to the high level. In response to this, the RS latch circuit 163 changes the pulse signal QOUT from the high level to the low level. In response to this, the slope voltage generation circuit 168 resets the slope voltage RAMP and the off-timer 140 starts measuring the off-time Toff. When the slope voltage RAMP is reset and RAMP<COMP, the first comparator 162 changes the first reset signal RST1 from the high level to the low level. The off-timer 140 changes the first set signal SET1 from the low level to the high level when the off-time Toff elapses. Thereafter, the same operation is repeated.

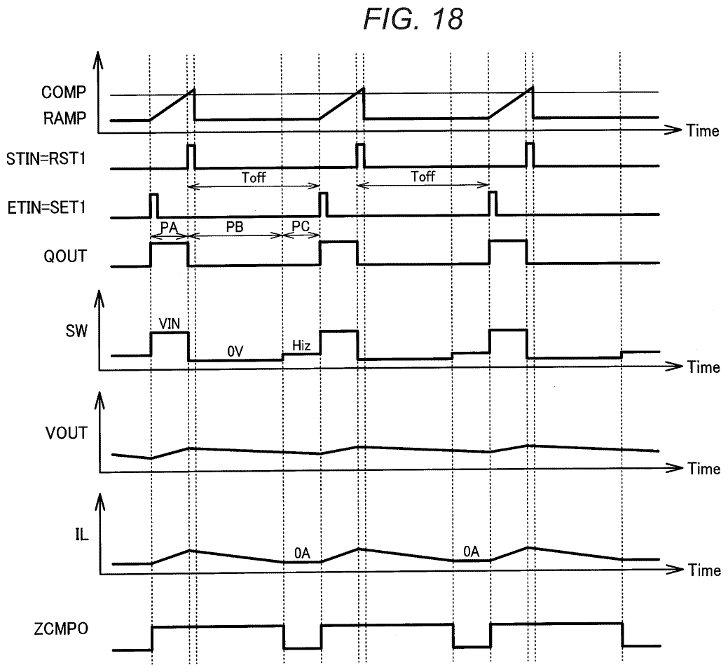

FIG. 18 is a waveform example illustrating a discontinuous operation in the first mode, that is, the voltage mode control. Here, it is assumed that the load current Id does not fluctuate. The discontinuous operation is an operation in the case in which the load current Id is relatively small and a reverse current of the inductor current IL occurs. Hereinafter, differences from FIG. 17 are mainly explained.

A period PC is a period in which the switching element 111 is off and the N-type MOS transistor 112 is off. In the period PC, the node NSW is in a high impedance state and the inductor current IL is 0 A. In the discontinuous operation, a period PA, a period PB, and a period PC constitute one cycle of switching.

In the discontinuous operation, the off-time Toff is equivalent to the period PB and the period PC. In the period PB, when the inductor current IL decreases and reaches 0 A, the reverse current detection signal ZCMPO changes the reverse current detection signal ZCMPO from the high level to the low level. In response to this, the pre-driver 170 changes the N-type MOS transistor 112 from on to off. Accordingly, the period PC starts and, since the N-type MOS transistor 112 is off, a reverse current of the inductor current IL is prevented. When the off-time Toff ends, the off-timer 140 changes the first set signal SET1 from the low level to the high level. Accordingly, the period PA starts and the same operation as the normal operation illustrated in FIG. 17 is performed until the period PB ends.

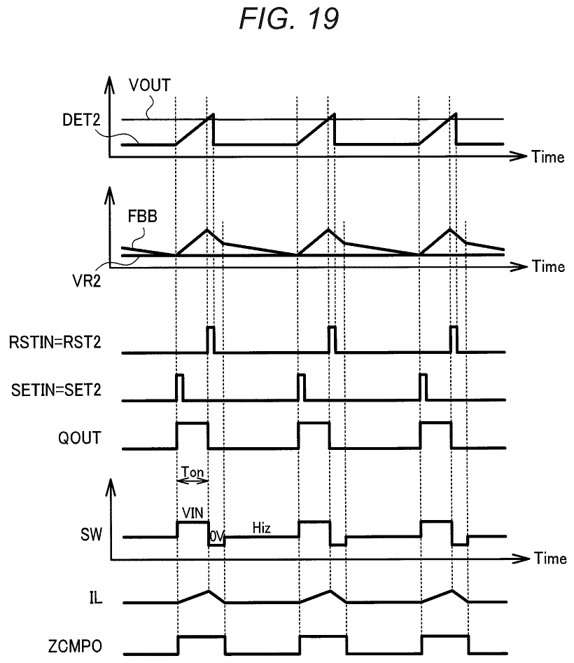

FIG. 19 is a waveform example illustrating the second mode, that is, the hysteresis control. Here, it is assumed that the load current Id does not fluctuate. Since the hysteresis control is selected when the load current Id is relatively small, a reverse current of the inductor current IL occurs.

When the voltage DET2 reaches the output voltage VOUT, the on-timer 340 determines that the on-time Ton has ended and changes the second reset signal RST2 from the low level to the high level. In response to this, the RS latch circuit 163 changes the pulse signal QOUT from the high level to the low level. In response to this, the on-timer 340 resets the voltage DET2 and changes the second reset signal RST2 from the high level to the low level. When the switching element 111 is turned off, since the output voltage VOUT drops, the second feedback voltage FBB drops. When the second feedback voltage FBB reaches the second reference voltage VR2, the second comparator 332 changes the second set signal SET2 from the low level to the high level. In response to this, the RS latch circuit 163 changes the pulse signal QOUT from the low level to the high level. In response to this, the on-timer 340 starts measuring the on-time Ton. When the switching element 111 is turned on, since the output voltage VOUT rises, the second feedback voltage FBB rises. Accordingly, the second comparator 332 changes the second set signal SET2 from the high level to the low level. Thereafter, the same operation is repeated. The operation of the reverse current detection circuit 180 is the same as the operation illustrated in FIG. 18.

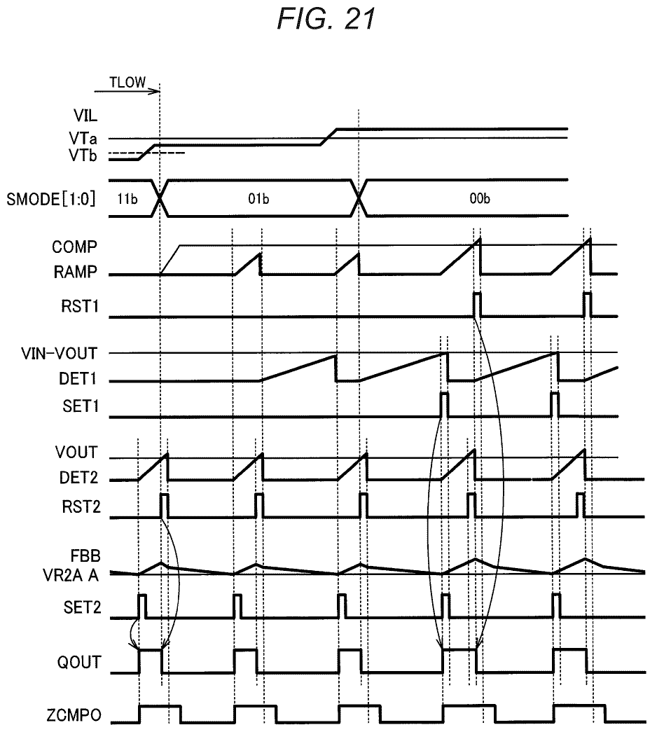

FIGS. 20 and 21 illustrate operation waveform examples of the switching regulator 200 at the time when the load current Id fluctuates. Here, an example in which the voltage mode control circuit 310 changes to the low power setting in the fourth mode as illustrated in FIG. 5 is explained. Although a waveforms are divided into FIG. 20 and FIG. 21, it is assumed that time continuously flows from FIG. 20 to FIG. 21.

When the load current Id decreases and the inductor current IL decreases, the voltage VIL drops. After the voltage VIL becomes smaller than the first threshold voltage VTa, the mode determination circuit 150 changes the mode signal SMODE [1:0] from 00b indicating the first mode to 01b indicating the third mode at timing when the reverse current detection signal ZCMPO first changes from the high level to the low level. After the voltage VIL becomes smaller than the second threshold voltage VTb, the mode determination circuit 150 changes the mode signal SMODE [1:0] from 01b indicating the third mode to 11b indicating the fourth mode at timing when the reverse current detection signal ZCMPO first changes from the high level to the low level.

When the load current Id increases and the inductor current IL increases, the voltage VIL rises. The mode determination circuit 150 changes the mode signal SMODE [1:0] from 11b indicating the fourth mode to 01b indicating the third mode at timing when the pulse signal QOUT first changes from the high level to the low level after the voltage VIL becomes equal to or higher than the second threshold voltage VTb. The mode determination circuit 150 changes the mode signal SMODE [1:0] from 01b indicating the third mode to 00b indicating the first mode at timing when the pulse signal QOUT first changes from the high level to the low level after the voltage VIL becomes equal to or higher than the first threshold voltage VTa.

When the load current Id decreases, the mode is switched on condition that the inductor current IL is actually small and a reverse current is detected, that is, when the reverse current detection signal ZCMPO changes from a high level to a low level. On the other hand, when the load current Id increases, since the inductor current IL does not need to be actually small, that is, a reverse current does not need to be detected, the mode only has to be switched when the pulse signal QOUT changes from the high level to the low level.

The switching regulator 200 operates according to the voltage mode control in the first mode as illustrated in FIG. 17 or 18 and operates according to the hysteresis control in the third mode and the fourth mode as illustrated in FIG. 19. In a period TLOW of the fourth mode, the voltage mode control circuit 310 is set to the low power. Specifically, bias currents of some or all of the error amplifier 161, the first comparator 162, the slope voltage generation circuit 168, and the off-timer 140 are stopped. FIGS. 20 and 21 illustrate an example in which all the bias currents are stopped. The error amplifier 161 stops generating the error voltage COMP, the slope voltage generation circuit 168 stops generating the slope voltage, the first comparator 162 does not perform the comparison operation, and the off-timer 140 stops the current source 141 and the variable current source 142 not to change the voltage DET1. In the third mode, the voltage mode control circuit 310 normally operates. For example, when the mode transitions from the fourth mode to the first mode, since the third mode is present between the fourth mode and the first mode, a time for the voltage mode control circuit 310 to return from the low power setting to the normal operation is provided.

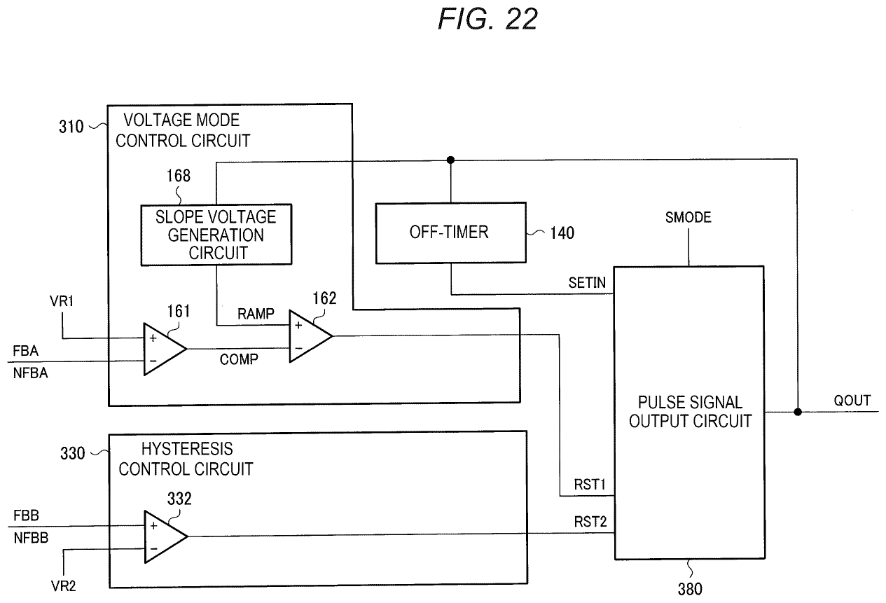

FIG. 22 is a second detailed configuration example of the voltage mode control circuit 310 and the hysteresis control circuit 330. In this configuration example, the off-timer 140 is provided in the control circuit 120 as a common element of the voltage mode control circuit 310 and the hysteresis control circuit 330.

The voltage mode control circuit 310 includes the error amplifier 161, the first comparator 162, and the slope voltage generation circuit 168. Operations of the circuits are the same as the operations illustrated in FIG. 13.

The hysteresis control circuit 330 includes the second comparator 332. The second comparator 332 compares the second feedback voltage FBB and the second reference voltage VR2 and outputs a result of the comparison as the second reset signal RST2. FIG. 22 illustrates an example in which the second feedback voltage FBB is input to a positive input terminal of the second comparator 332 and the second reference voltage VR2 is input to a negative input terminal thereof.

The off-timer 140 starts a timer when the pulse signal QOUT changes from the high level to the low level, that is, when the switching element 111 changes from ON to OFF. When the off-timer 140 measures elapse of the off-time, the off-timer 140 changes the set signal SETIN from the low level to the high level. Accordingly, as is explained below, the pulse signal QOUT changes from the low level to the high level and, in response to this, the off-timer 140 resets the timer and changes the set signal SETIN from the high level to the low level. The length of the off-time may be fixed or may be variably controlled according to the inductor current IL as explained with reference to FIG. 15.

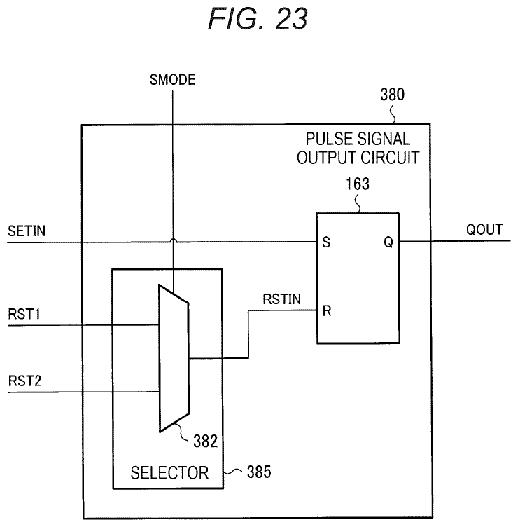

FIG. 23 is a second detailed configuration example of the pulse signal output circuit 380. The pulse signal output circuit 380 includes the selector 385 and the RS latch circuit 163.

The set signal SETIN from the off-timer 140 is input to the RS latch circuit 163. The selector 385 selects, based on the mode signal SMODE, the first reset signal RST1 or the second reset signal RST2 as the reset signal RSTIN of the RS latch circuit 163. Specifically, the selector 385 includes the second selector 382. The second selector 382 selects the first reset signal RST1 as the reset signal RSTIN at the time of the first mode and selects the second reset signal RST2 as the reset signal RSTIN at the time of the second mode.

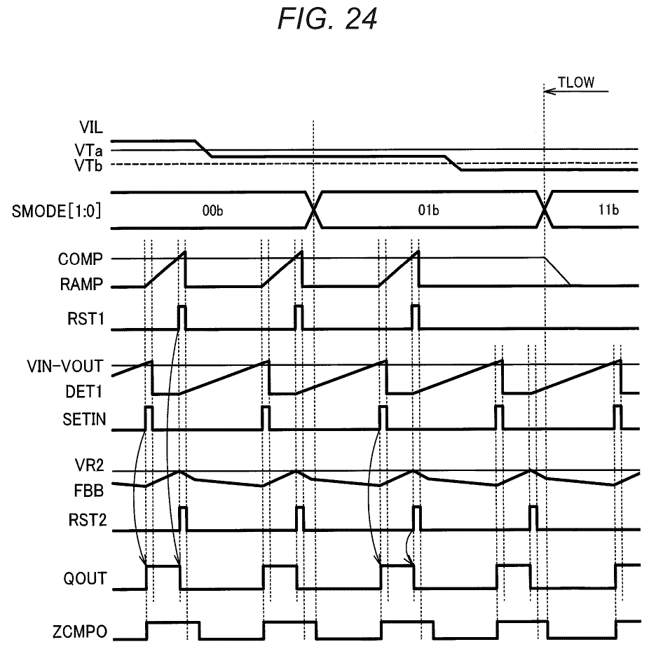

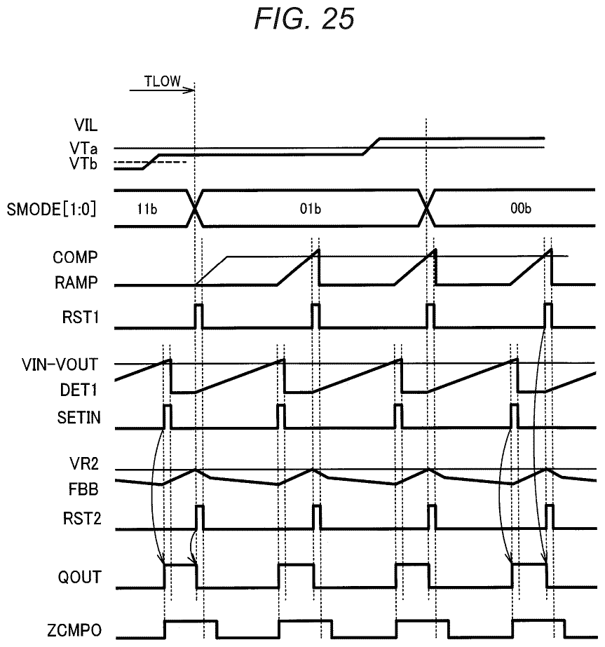

FIGS. 24 and 25 illustrate operation waveform examples of the switching regulator 200 to which the second detailed configuration example is applied. Here, an example in which the voltage mode control circuit 310 changes to the low power setting in the fourth mode as illustrated in FIG. 5 is explained. Although a waveform is divided into FIG. 24 and FIG. 25, it is assumed that time continuously flows from FIG. 24 to FIG. 25. Hereinafter, differences from FIGS. 20 and 21 are mainly explained.

When the second feedback voltage FBB rises and reaches the second reference voltage VR2, the second comparator 332 changes the second reset signal RST2 from the low level to the high level. When the pulse signal QOUT changes from the high level to the low level, the switching element 111 is turned on, the output voltage VOUT drops, and the second feedback voltage FBB decreases. For this reason, the second comparator 332 changes the second reset signal RST2 from the high level to the low level.

Since the off-timer 140 is shared in the voltage mode control and the hysteresis control, the off-timer 140 does not change to the low power setting and performs the normal operation even in the fourth mode. In the fourth mode, bias currents of some or all of the error amplifier 161, the first comparator 162, and the slope voltage generation circuit 168 are stopped.

In the present embodiment, the control circuit 120 includes the voltage mode control circuit 310 that performs the voltage mode control, the hysteresis control circuit 330 that performs the hysteresis control, the pulse signal output circuit 380, and the pre-driver 170. The pulse signal output circuit 380 outputs the pulse signal QOUT based on an output signal of the voltage mode control circuit 310 in the first mode and outputs the pulse signal QOUT based on an output signal of the hysteresis control circuit 330 in the second mode. The pre-driver 170 performs switching control on the switching element 111 based on the pulse signal QOUT. At least some of the circuits of the voltage mode control circuit 310 change to the low power setting, which is a stopped or low power consumption state in at least a part of the period of the second mode.

For example, the voltage mode control circuit 310 changes to the low power setting in a part of the period of the second mode in the examples illustrated in FIGS. 5 and 7 and in the entire period of the second mode in the example illustrated in FIG. 6.

According to the present embodiment, the hysteresis control is selected at the time of the low load and at least some of the circuits of the voltage mode control circuit 310 not in use change to the low power setting. Therefore, the power consumption of the switching regulator 200 at the time of the low load can be reduced. At the time of the low load, the power consumption of the switching regulator 200 is a factor that reduces the power efficiency but the power efficiency can be improved by reducing the power consumption.

As explained with reference to FIG. 5 and the like, the second mode may include the third mode in which the low power setting is not performed and the fourth mode in which the low power setting is performed. The mode determination circuit 150 may compare the inductor current IL and the first threshold ITa and compare the inductor current IL and the second threshold ITb smaller than the first threshold ITa. The mode determination circuit 150 may determine that the mode is the first mode when the inductor current IL is equal to or larger than the first threshold ITa, determine that the mode is the third mode when the inductor current IL is smaller than the first threshold ITa and equal to or larger than the second threshold ITb, and determine that the mode is the fourth mode when the inductor current IL is smaller than the second threshold ITb. At least some of the circuits of the voltage mode control circuit 310 may not change to the low power setting when the mode determination circuit 150 determines that the mode is the third mode and may change to the low power setting when the mode determination circuit 150 determines that the mode is the fourth mode.

According to the present embodiment, when the load current Id rises and transitions from the fourth mode to the first mode, the voltage mode control circuit 310 does not change to the low power setting in the third mode during the transition. In the third mode, the hysteresis control is performed and the voltage mode control circuit 310 is not used. Accordingly, when the voltage mode control circuit 310 transitions from the low power setting in the fourth mode to the normal operation in the first mode, a time until an operating point is determined in the third mode is provided, and the voltage mode control circuit 310 can transition to the first mode after returning to the operating point where the voltage mode control circuit 310 can appropriately operate.

As explained with reference to FIG. 6, the mode determination circuit 150 may compare the inductor current IL and the first threshold ITa. The mode determination circuit 150 may determine that the mode is the first mode when the inductor current IL is equal to or larger than the first threshold ITa and determine that the mode is the second mode when the inductor current IL is smaller than the first threshold ITa. At least some of the circuits of the voltage mode control circuit 310 may change to the low power setting when the mode determination circuit 150 determines that the mode is the second mode.

According to the present embodiment, the voltage mode control circuit 310 can be changed to the low power setting in the second mode in which the hysteresis control is performed, and the power consumption of the switching regulator 200 at the time of the low load can be reduced. In the present embodiment, the voltage mode control circuit 310 may include the error amplifier 161, the slope voltage generation circuit 168, and the first comparator 162. The error amplifier 161 may receive input of the first feedback voltage FBA corresponding to the output voltage VOUT, amplify the error between the first feedback voltage FBA and the first reference voltage VR1, and output the error voltage COMP. The slope voltage generation circuit 168 may generate the slope voltage RAMP. The first comparator 162 may compare the error voltage COMP and the slope voltage RAMP. The hysteresis control circuit 330 may include the second comparator 332. The second comparator 332 may receive input of the second feedback voltage FBB corresponding to the output voltage VOUT and compare the second feedback voltage FBB and the second reference voltage VR2. The pulse signal output circuit 380 may output the pulse signal QOUT based on an output signal of the first comparator 162 in the first mode and may output the pulse signal QOUT based on an output signal of the second comparator 332 in the second mode.

According to the present embodiment, in the first mode, the output voltage VOUT can be controlled to the given constant voltage according to the voltage mode control based on the first feedback voltage FBA corresponding to the output voltage VOUT. In the second mode, the output voltage VOUT can be controlled to the given constant voltage according to the hysteresis control based on the second feedback voltage FBB corresponding to the output voltage VOUT.

As explained with reference to FIGS. 13 and 14, the voltage mode control circuit 310 may include the off-timer 140 that sets the length of the off-time in which the switching element 111 is off. The hysteresis control circuit 330 may include the on-timer 340 that sets the length of the on-time in which the switching element 111 is on. The pulse signal output circuit 380 may include the RS latch circuit 163 that outputs the pulse signal QOUT and the selector 385 that selects the set signal SETIN and the reset signal RSTIN of the RS latch circuit 163. In the first mode, the selector 385 may output an output signal of the off-timer 140 as the set signal SETIN and output an output signal of the first comparator 162 as the reset signal RSTIN. In the second mode, the selector 385 may output an output signal of the second comparator 332 as the set signal SETIN and output an output signal of the on-timer 340 as the reset signal RSTIN.

In this way, the switching element 111 can be subjected to switching control based on a result of the voltage mode control in the first mode and the switching element 111 can be subjected to switching control based on a result of the hysteresis control in the second mode.

As explained with reference to FIGS. 22 and 23, the control circuit 120 may include the off-timer 140 that sets the length of the off-time in which the switching element 111 is off. The pulse signal output circuit 380 may include the RS latch circuit 163 that outputs the pulse signal QOUT and the selector 385 that selects the reset signal RSTIN of the RS latch circuit 163. An output signal of the off-timer 140 may be input to the RS latch circuit 163 as the set signal SETIN. The selector 385 may output an output signal of the first comparator 162 as the reset signal RSTIN in the first mode and output an output signal of the second comparator 332 as the reset signal RSTIN in the second mode.

With such a configuration as well, the switching element 111 can be subjected to switching control based on a result of the voltage mode control in the first mode and the switching element 111 can be subjected to switching control based on a result of the hysteresis control in the second mode.

As explained with reference to FIG. 7, at least some of the circuits of the hysteresis control circuit 330 may change to the low power setting, which is a stop or low power consumption state, in the first mode.

According to the present embodiment, the power consumption of the switching regulator 200 can be reduced in the first mode in which the voltage mode control is performed.

In the present embodiment, the circuit device 100 may include the reverse current detection circuit 180 that detects a reverse current of the inductor current IL. When determining that the inductor current IL is smaller than the first threshold ITa, the mode determination circuit 150 may switch the mode from the first mode to the second mode at timing when the reverse current detection circuit 180 detects a reverse current.

In the present embodiment, when determining that the inductor current IL is equal to or larger than the first threshold, the mode determination circuit 150 may switch the mode from the second mode to the first mode at timing when the switching element 111 is changed from on to off.

According to the present embodiment, when the load current Id decreases, the mode can be switched on the condition that the inductor current IL is actually small and a reverse current is detected. On the other hand, when the load current Id increases, since the inductor current IL does not need to be actually small, that is, a reverse current does not need to be detected, the mode only has to be switched when the pulse signal QOUT changes from the high level to the low level.

In the present embodiment, the current detection voltage VIL only has to be input to the mode determination circuit 150 from the current detection circuit 190. The current detection circuit 190 may convert the inductor current IL into the current detection voltage VIL corresponding to the inductor current IL. The mode determination circuit 150 may compare the current detection voltage VIL and the first threshold voltage VTa corresponding to the first threshold ITa of the inductor current IL to compare the inductor current IL and the first threshold ITa and determine the first mode and the second mode based on a comparison result.

According to the present embodiment, the mode determination circuit 150 can compare the current detection voltage VIL and the first threshold VTa corresponding to the first threshold ITa of the inductor current IL to compare the inductor current IL and the first threshold ITa.

Although the present embodiment is explained in detail as explained above, those skilled in the art could easily understand that many modifications can be made without substantially departing from the novel matters and the effects of the present disclosure. Therefore, all such modifications are deemed to be included in the scope of the present disclosure. For example, a term described at least once together with a different term having a broader meaning or the same meaning in the specification or the drawings can be replaced with the different term in any place in the specification or the drawings. All combinations of the present embodiment and the modifications are also included in the scope of the present disclosure. The configurations, operations, and the like of the mode determination circuit, the voltage mode control circuit, the hysteresis control circuit, the pulse signal output circuit, the pre-driver, the first voltage divider circuit, the second voltage divider circuit, the control circuit, the circuit device, the load, the switching regulator, and the like are not limited to those explained in the present embodiment, and various modifications can be made.

What is claimed is:

1. A circuit device used for a switching regulator that outputs an output voltage obtained by regulating a power supply voltage with an inductor and a switching element that drives the inductor, the circuit device comprising:
a control circuit configured to perform voltage mode control or hysteresis control for controlling the output voltage to a given constant voltage and perform switching control on the switching element based on a result of the voltage mode control or the hysteresis control; and
a mode determination circuit configured to determine, based on an inductor current flowing to the inductor, a first mode in which the voltage mode control is performed and a second mode in which the hysteresis control is performed, wherein
the control circuit performs the switching control on the switching element based on the result of the voltage mode control when the mode determination circuit determines that a mode is the first mode and performs the switching control on the switching element based on a result of the hysteresis control when the mode determination circuit determines that the mode is the second mode.

2. The circuit device according to claim 1, wherein the mode determination circuit compares the inductor current and a first threshold, determines that the mode is the first mode when the inductor current is equal to or larger than the first threshold, and determines that the mode is the second mode when the inductor current is smaller than the first threshold.

3. The circuit device according to claim 1, wherein
the control circuit includes:
a voltage mode control circuit configured to perform the voltage mode control;
a hysteresis control circuit configured to perform the hysteresis control;
a pulse signal output circuit configured to output a pulse signal based on an output signal of the voltage mode control circuit in the first mode and outputs the pulse signal based on an output signal of the hysteresis control circuit in the second mode; and
a pre-driver configured to perform switching control on the switching element based on the pulse signal, and
at least some of the circuits of the voltage mode control circuit change to low power setting, which is a stop or low power consumption state in at least a part of a period of the second mode.

4. The circuit device according to claim 3, wherein
the second mode includes a third mode in which the low power setting is not performed and a fourth mode in which the low power setting is performed,
the mode determination circuit compares the inductor current and a first threshold and compares the inductor current and a second threshold smaller than the first threshold, determines that the mode is the first mode when the inductor current is equal to or larger than the first threshold, determines that the mode is the third mode when the inductor current is smaller than the first threshold and equal to or larger than the second threshold, and determines that the mode is the fourth mode when the inductor current is smaller than the second threshold, and
the at least some of the circuits of the voltage mode control circuit do not change to the low power setting when the mode determination circuit determines that the mode is the third mode and changes to the low power setting when the mode determination circuit determines that the mode is the fourth mode.

5. The circuit device according to claim 3, wherein
the mode determination circuit compares the inductor current and a first threshold, determines that the mode is the first mode when the inductor current is equal to or larger than the first threshold, and determines that the mode is the second mode when the inductor current is smaller than the first threshold, and
the at least some of the circuits of the voltage mode control circuit change to the low power setting when the mode determination circuit determines that the mode is the second mode.

6. The circuit device according to claim 3, wherein
the voltage mode control circuit includes:
an error amplifier to which a first feedback voltage corresponding to the output voltage is input, the error amplifier amplifying an error between the first feedback voltage and a first reference voltage to output an error voltage;
a slope voltage generation circuit configured to generate a slope voltage; and
a first comparator configured to compare the error voltage and the slope voltage,
the hysteresis control circuit includes a second comparator to which a second feedback voltage corresponding to the output voltage is input, the second comparator comparing the second feedback voltage and a second reference voltage, and
the pulse signal output circuit outputs the pulse signal based on an output signal of the first comparator in the first mode and outputs the pulse signal based on an output signal of the second comparator in the second mode.

7. The circuit device according to claim 6, wherein
the voltage mode control circuit includes an off-timer configured to set length of an off-time in which the switching element is off,
the hysteresis control circuit includes an on-timer configured to set length of an on-time in which the switching element is on,
the pulse signal output circuit includes:
an RS latch circuit configured to output the pulse signal; and
a selector configured to select a set signal and a reset signal of the RS latch circuit, and
the selector outputs an output signal of the off-timer as the set signal and outputs an output signal of the first comparator as the reset signal in the first mode and outputs an output signal of the second comparator as the set signal and outputs an output signal of the on-timer as the reset signal in the second mode.

8. The circuit device according to claim 6, wherein
the control circuit includes an off-timer configured to set length of an off-time in which the switching element is off,
the pulse signal output circuit includes an RS latch circuit to which an output signal of the off-timer is input as a set signal, the RS latch circuit outputting the pulse signal; and
a selector configured to select a reset signal of the RS latch circuit, and
the selector outputs an output signal of the first comparator as the reset signal in the first mode and outputs an output signal of the second comparator as the reset signal in the second mode.

9. The circuit device according to claim 1, wherein
the control circuit includes:
a voltage mode control circuit configured to perform the voltage mode control;
a hysteresis control circuit configured to perform the hysteresis control;
a pulse signal output circuit configured to output a pulse signal based on an output signal of the voltage mode control circuit in the first mode and outputs the pulse signal based on an output signal of the hysteresis control circuit in the second mode; and
a pre-driver configured to perform switching control on the switching element based on the pulse signal, and
at least some of circuits of the hysteresis control circuit change to low power setting, which is a stop or low power consumption state in the first mode.

10. The circuit device according to claim 1, further comprising a reverse current detection circuit configured to detect a reverse current of the inductor current, wherein
when determining that the inductor current is smaller than a first threshold, the mode determination circuit switches the mode from the first mode to the second mode at timing when the reverse current detection circuit detects the reverse current.

11. The circuit device according to claim 1, wherein, when determining that the inductor current is equal to or larger than a first threshold, the mode determination circuit switches the mode from the second mode to the first mode at timing when the switching element changes from on to off.

12. The circuit device according to claim 1, wherein
the mode determination circuit receives input of the current detection voltage from a current detection circuit that converts the inductor current into a current detection voltage corresponding to the inductor current, compares the current detection voltage and a first threshold voltage corresponding to a first threshold of the inductor current to compare the inductor current and the first threshold, and determines the first mode and the second mode based on a comparison result.

13. A switching regulator comprising:
the circuit device according to claim 1;
the switching element; and
the inductor.
